(19) United States
(12) Patent Application Publication
(10) Pub. No.: US 2022/0371148 A1
(43) Pub. Date: Nov. 24, 2022

(54) WHEEL POLISHING DEVICE

(71) Applicants: Todd Kaptein, Zeeland, MI (US); Michael Lowery, Zeeland, MI (US)

(72) Inventors: Todd Kaptein, Zeeland, MI (US); Michael Lowery, Zeeland, MI (US)

(21) Appl. No.: 17/749,490

(22) Filed: May 20, 2022

Related U.S. Application Data
(60) Provisional application No. 63/191,221, filed on May 20, 2021.

(51) Int. Cl. B24B 29/02; B24B 41/06

(52) U.S. Cl. CPC B24B 29/02; B24B 41/06

(57) ABSTRACT

A wheel polishing device is provided and configured to be used with a polishing stand. The device includes a base plate defining a plurality of tracks and a plurality of peg members. Each of the plurality of peg members configured to slidably engage a least one of the plurality of tracks defined by the plate. A peg expanding hub is configured to expand into the plurality of peg members when a nut is tightened on a center screw that passes through the peg expanding hub.

### CROSS-REFERENCE TO RELATED APPLICATIONS

The present application claims priority to U.S. Provisional application No. 63/191,221, entitled “Gripping Apparatus” filed on May 20, 2021, the disclosure of which is hereby incorporated in its entirety at least by reference.

### BACKGROUND OF THE INVENTION

### 1. Field of the Invention

The present invention relates generally to automotive detailing devices and more particularly to wheel polishing device configured to be coupled to a wheel polishing stand.

### 2. Description of Related Art

A wheel polishing stand or wheel detailing stand is a detailing product that allows a wheel to be attached such that the wheel may be rotated to make the detailing or cleaning process easier. Generally, the wheel may also include the tire. When polishing forged wheels, damage could occur to the wheel when attaching it to the wheel polishing stand. The wheel polishing devices of the prior art feature sharp teach or poor designs which lead to wheel damage. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention is to provide a wheel polishing device configured to attach to a wheel polishing stand suitable for forged wheels, and particularly smaller forged wheels. It is another object of the present invention to provide a wheel polishing device configured for use with a mechanical human powered system, i.e. no electric motors or electronics. It is yet another object of the present invention to provide a portable system.

In order to do so, a wheel polishing device configured to couple with a wheel polishing stand is provided, the wheel polishing device comprising a base plate member defining a plurality of tracks; a plurality peg members, wherein each of the plurality of peg members are configured to slidably engage a track of the plurality of tracks defined by the base plate member; and a peg expanding hub positioned centrally approximate to the base plate member, the peg expanding hub having a central aperture and an internal seat; a center screw configured to pass through the central aperture of the peg expanding hub; a nut configured to rotate on the center screw and engage the internal seat, wherein the nut is configured to push the internal seat and the peg expanding hub downwardly toward the base plate member, which pushes the plurality of peg member outwardly along the tracks such that the plurality of peg members are configured to engage an inner piloting diameter of a wheel to secure the wheel to the wheel polishing device.

In one embodiment, the rotational movement of the nut along the center screw in a downward direction moves the plurality of pegs in an outward direction, against an inwardly directed force created by one or more biasing members. In another embodiment, the rotational movement of the nut along the center screws in an upward direction moves the plurality of peg members in an inward direction. In one embodiment, the base plate member comprises three angled tracks that are machined at 120 degree increments about a circumference of the peg expanding hub. In another embodiment, the plurality of peg members is 3. In one embodiment, at least one of the plurality of peg members define one or more cavities to removably engage at least one biasing member. In yet another embodiment, the one or more cavities are defined along an outer surface of each peg of the plurality of peg members. In one embodiment, each peg of the plurality of peg members comprises an incline surface positioned against a matching incline surface on the peg expanding hub. In another embodiment, the downward force of the nut on the internal seat engages the matching incline surface of the peg expanding hub along at least a portion of this incline surface of the plurality of peg members, such that each of the plurality of peg members moves along one of the plurality of the tracks. In another embodiment, the incline surface extends only along a portion of a surface of each peg of the plurality of peg members. In one embodiment, the peg expanding hub is cylindrical. In another embodiment, each peg of the plurality of peg members defines a width associated with a specific inner diameter range of the inner dimeter of the piloting diameter of the wheel. In yet another embodiment, the plurality of peg members may be exchanged with an alternative set of plurality of peg members having a second width such that the wheel polishing device may be used with other inner diameter ranges of different wheel's piloting diameters. In one embodiment, the wheel polishing stand is manually powered.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a wheel polishing stand and a wheel polishing device according to an embodiment of the present invention.

FIG. 2 is an exploded view of the wheel polishing stand and portions of the wheel polishing device according to an embodiment of the present invention.

FIG. 3 is a top view of a base plate of the wheel polishing device according to an embodiment of the present invention.

FIG. 4A is a bottom perspective view of a peg expanding hub of the wheel polishing device according to an embodiment of the present invention.

FIG. 4B is a top view of the peg expanding hub of FIG. 4A.

FIG. 4C is a section view of the peg expanding hub of FIG. 4B.

FIG. 5A is a perspective view of a first peg member according to an embodiment of the present invention.

FIG. 5B is a side view of FIG. 5A.

FIG. 6A is a perspective view of a second peg member according to an embodiment of the present invention.

FIG. 6B is a side view of FIG. 6A.

FIG. 7A is a perspective view of a third peg member according to an embodiment of the present invention.

FIG. 7B is a side view of FIG. 7A.

FIG. 8A a perspective view of the wheel polishing device with first peg members installed according to an embodiment of the present invention.

FIG. 8B a perspective view of the wheel polishing device with second peg members installed according to an embodiment of the present invention.

FIG. 8C a perspective view of the wheel polishing device with third peg members installed according to an embodiment of the present invention.

FIG. 9A is a top view of the wheel polishing device with first peg members installed according to an embodiment of the present invention.

FIG. 9B is a top view of the wheel polishing device with second peg members installed according to an embodiment of the present invention.

FIG. 9C is a top view of the wheel polishing device with third peg members installed according to an embodiment of the present invention.

FIG. 10 is a detailed perspective view of the wheel polishing device in use according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a wheel polishing device.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

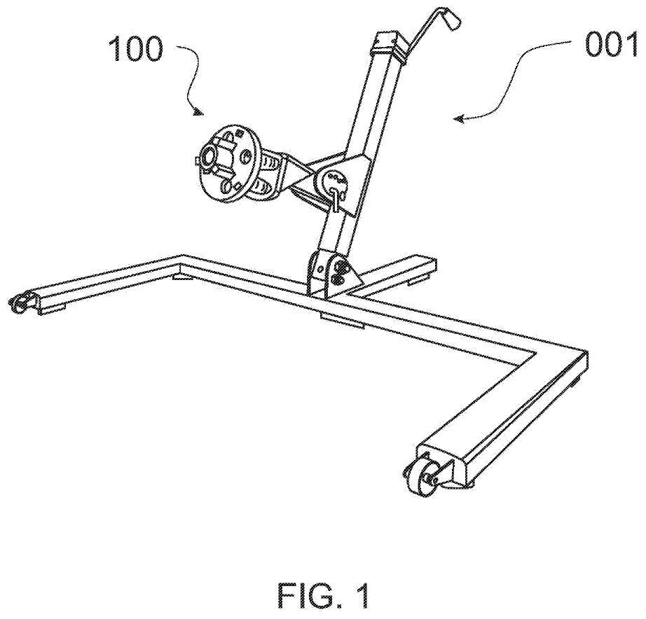

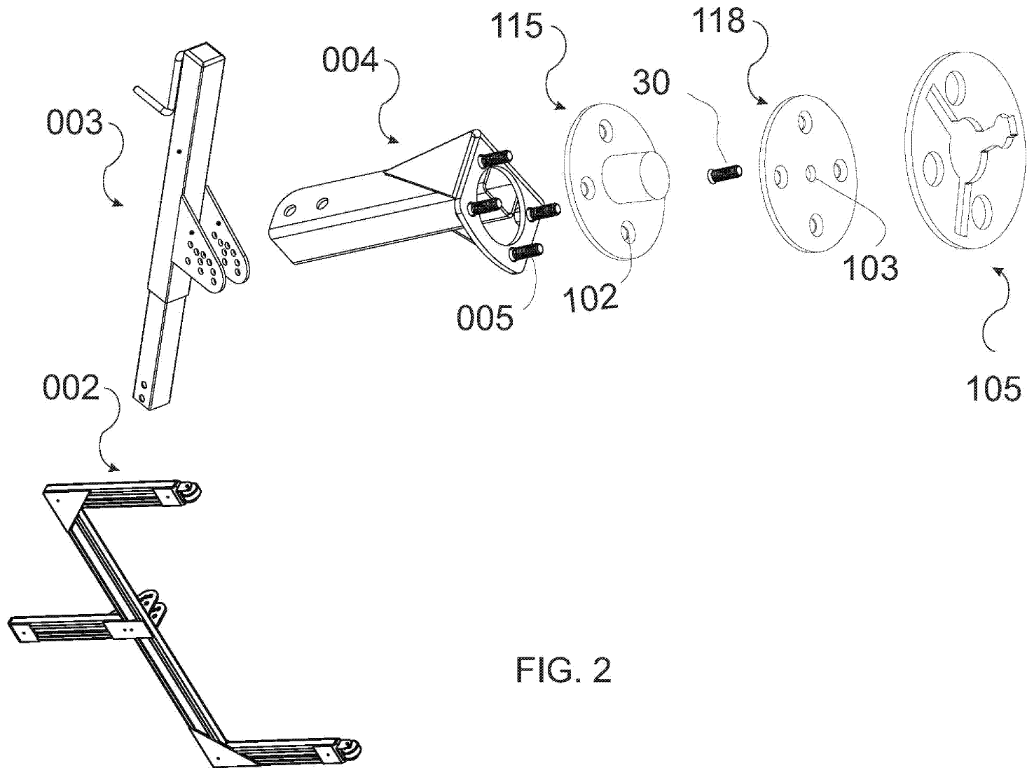

Referring now to FIGS. 1-2, a perspective view and exploded view of a wheel polishing stand 001 and a wheel polishing device 100 is illustrated. The wheel polishing stand 001 and a wheel polishing device 100 defining a wheel polishing system. In one embodiment, the wheel polishing stand 001 is configured to hold a support arm 003 via stand 002, wherein the support arm may receive interchangeable support member 004 which is configured to receive the wheel polishing device of the present invention. As previously mentioned, the wheel polishing device 100 of the present invention is intended to be used with smaller forged wheels. However, a user if desired may exchange the support member 004 such that other types and sizes of wheels may be used.

In one embodiment, a bearing member (wheel hub assembly) 115 is configured to be secured to the interchange support member 004 via connection bolts 005 into corresponding bolt holes 102, wherein the bearing member 115 is configured to rotate about the support member 004. A backing plate member 118 is configured to couple to the bearing member in any method known in the art. A centrally threaded rod or center screw 30 is configured to pass through a center hole 103 of the backing plate 118. The details of the center screw 30 will be discussed in further details below. A base plate member 105 is configured to be coupled to the backing plate member 118, wherein the base plate member is preferably circular. In one embodiment, the base plate member 105 is coupled to the backing plate member.

The details and components of the wheel polishing device will be discussed, but its purpose is to hold, grip, or clamp a wheel or rim (with or without a tire) such that it may be rotated via the wheel polishing stand 001. The wheel polishing device of the present invention is configured to hold the wheel via the wheel's center hole or piloting diameter. During use, a wheel is rotated, via the wheel polishing stand 001 manually by a user, facilitating an ease of detailing the wheel. More specifically, the wheel polishing stand 001 is configured to lift the wheel off the ground. The user can then use a grinder with an airway attached to polish the rim with polishing compound or rouge. Further, since the mounted wheel can spin freely on the wheel polishing stand, a rotational motion of a user's grinding wheel will rotate or turn the mounted tire or mounted wheel.

For example, in one embodiment, a rotational movement or rotational motion of the polishing wheel stand and the angle of pressure transfer to the wheel creates a motion that rotates the wheel for a controlled and even polish or the wheel may be manually rotated via turning, or other means configured to rotate the wheel. The interface between the wheel to be serviced and the fixed wheel stand is the wheel polishing device 100. A first end of this system 100 comprises the bearing member allowing rotation about the fixed stand. In one embodiment, the bearing member is a wheel hub assembly. A second end of the devices interfaces with the wheel is of an expanding design that can be used to clamp the wheel both axially and radially. Advantageously, the present invention is configured to clamp a soft forged wheel, such as constructed from aluminum, without damaging the wheel during the process.

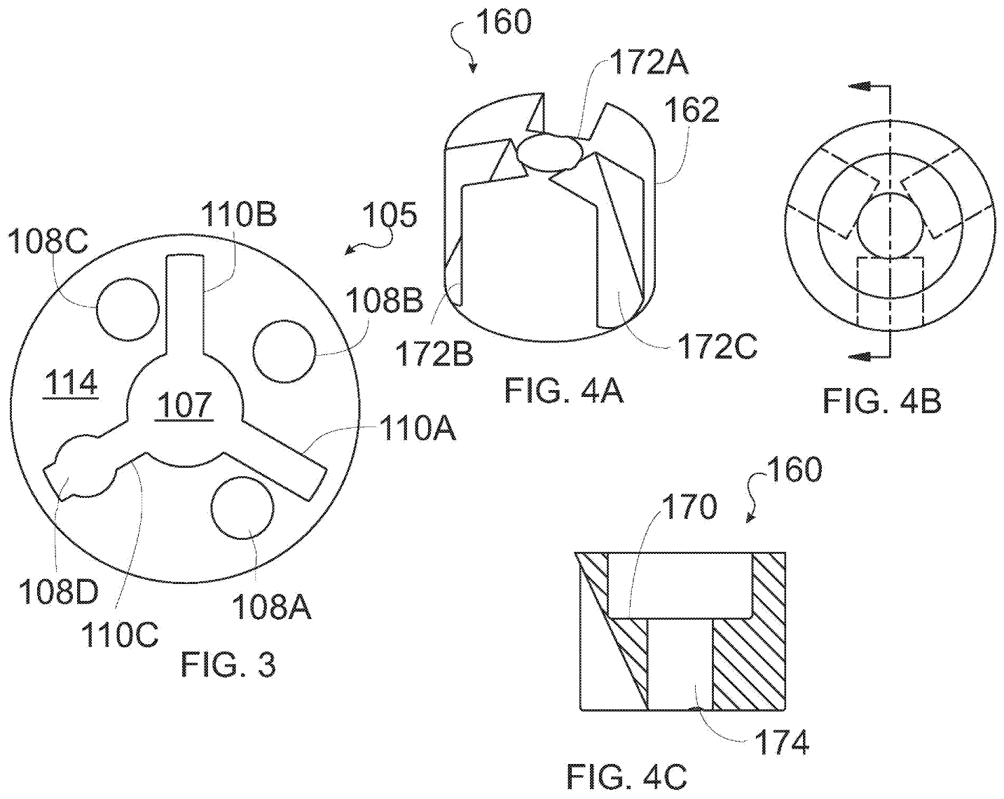

Referring now to any of the accompanying FIGS. 3-9C, the wheel polishing device is illustrated. In one embodiment, the base plate member 105 is constructed as a circular disk configured to receive components of the device on the top surface 114. In some embodiments, the base plate member 105 comprises a plurality of apertures 108A, 108B, 108C, and 108D enabling the base plate member to be coupled to the wheel polishing stand via the backing plate member as previously discussed. In some embodiments, the base plate member 105 further comprises a plurality of tracks 110A, 110B, and 110C, wherein the tracks are machined within the top surface of the base plate member or through the base plate member. In one embodiment, the plurality of tracks includes three angled tracks positioned at 120 degree increments about a circumference of the base plate member 105. In some embodiments, the base plate member 105 further comprises a central aperture 107 configured to receive a peg expanding hub 160. In one embodiment, the central aperture 107 is circular and the peg expanding hub 160 is cylindrical 162 sized to fit within the central aperture 107. The peg expanding hub 160 includes a plurality of angled surfaces 172A, 172B, 172C corresponding to the number of tracks provided on the base plate member 105. In one embodiment, the peg expanding hub 160 further comprises center hole 174 and internal seat 170. The function of the peg expanding hub will be discussed in greater details below.

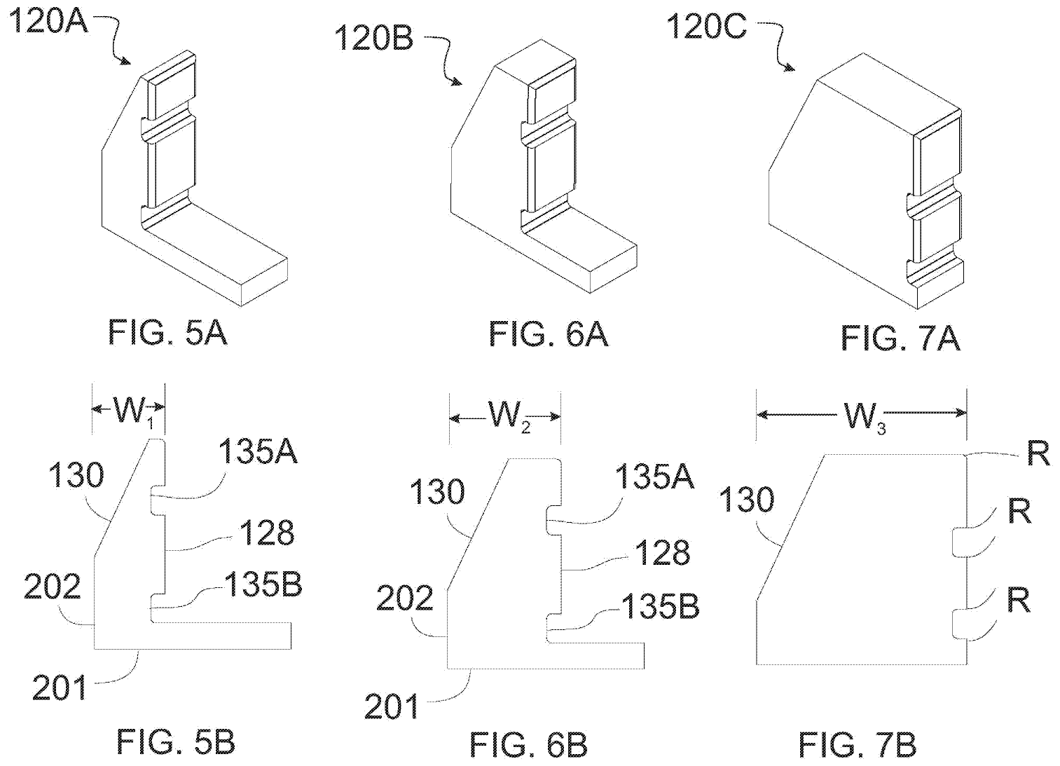

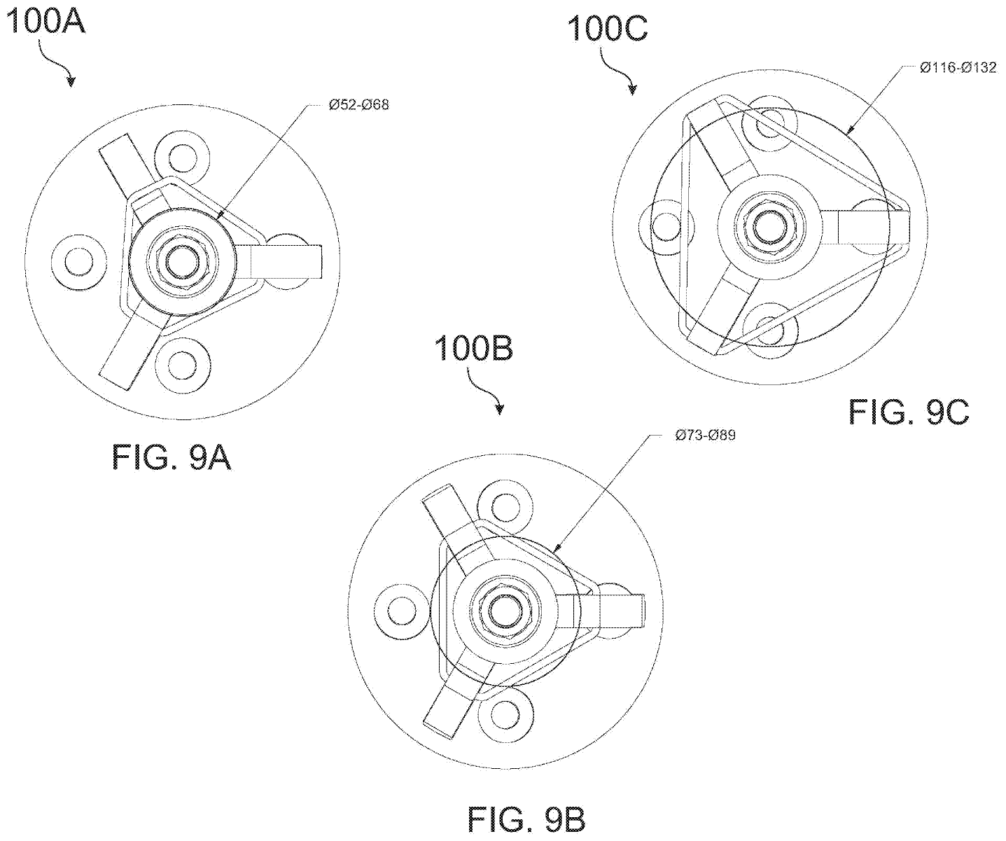

Best seen in FIGS. 5A-7B, the wheel polishing device comprises a plurality of pegs 120A, 120B, and 120C. The pegs are configured to be used and slid within the tracks 110A-C of the base plate member 105. The number of pegs used is determined by the number of tracks provided. In the preferred embodiments, three tracks are provided and thus three pegs are used. The specific peg used 120A, 120B, or 120C depends on the size of the wheel configured to be polished by the device. FIGS. 9A-C shows a range in piloting dimeter for wheel size using each type of peg. For instance, the small peg 120A having a width W₁ is configured to be used with wheels having an inner piloting diameter of 52 to 68 millimeters. The medium peg 120B having width W₂ is configured to be used with wheels having an inner piloting diameter of 73 to 89 millimeters. The large peg 120B having width W₃ is configured to be used with wheels having an inner piloting diameter of 116 to 132 millimeters. It should be understood that other peg widths may be provided so the device can be used with other sized wheels.

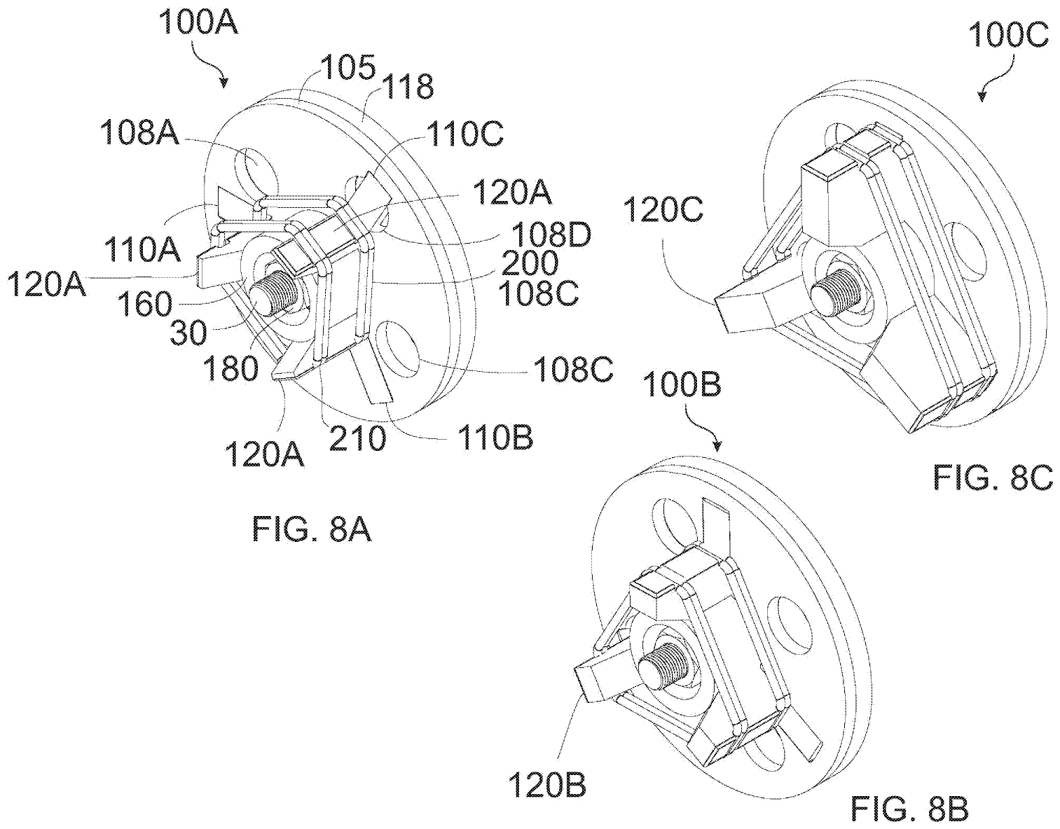

Referring to FIGS. 5A-9C, each peg has a similar construction with a variable width, W₁, W₂, and W₃ for peg 120A, 120B, and 120C respectively. In one embodiment, the pegs 120A-C are retained about the peg expanding hub 160 with one or more biasing members 200, 210, such as one or more silicone elastic bands. For example, the wheel polishing device 100 illustrated in FIG. 8A illustrates two elastic bands 200, 210 that apply an inwardly directed force, forcing the pegs 120A towards the peg expanding hub 160 while the pegs remain seated with their respective tracks or slots 110A-C.

Best seen in FIG. 8A, each of the pegs 120A is configured to slidably engage a least one of the plurality of tracks 110A-C defined by the base plate member 105. For example, a first peg 120A is configured to slidably engage a first track 110A defined by the base plate member 105, wherein the bottom surface 201 of the first peg 120A is slidably engaged with the first track 110A. Similarly, a second peg 120A and a third peg 120A are configured to slidably engage a second track 110b and a third track 110c defined by the base plate member 105, respectively.

In this illustrated embodiment, three pegs 120A are utilized. For example, the plurality of pegs may comprise three pegs, wherein each of the three pegs is positioned equally distant from one another along the first surface 114 of the base plate member 105. However, those of ordinary skill in the art will recognize, alternative clamping fingers or clamping member arrangements may also be utilized.

FIGS. 5A-B, illustrates a first arrangement of a peg 120A. As illustrated, the peg has a first surface 130 and a second surface 128. As mounted in the device 100, the first surface 130 of the peg 120A will extend inwardly, towards the peg expanding hub 160. As illustrated, when the clamping member is positioned along the top surface 114 of the base plate member 105, the second surface 128 of the peg extends outwardly, away from the first surface 130. For example, with respect to the peg 120A, when the peg is positioned along the top surface 114 of the base plate member 105, the second surface 128 of the peg extends outwardly, away from the first surface 130.

As illustrated, the second surface 128 comprises a generally smooth, linear surface. However, alternative surface configurations may also be used. As just one example, the second surface 128 may comprise a convex surface. As previously mentioned, the device, and more particularly the plurality of tracks are configured to receive different sized pegs. These different sized pegs may be selected to grip or mount different sized wheels to a wheel polishing stand, such as the wheel polishing stand 001 illustrated in FIG. 1

In one embodiment, the first surface 130 is a machined incline 130. For example, as illustrated in FIG. 5B, the machined incline 130 extends along only a portion of a length of this surface. The pegs 120B, 120C illustrated in FIGS. 6B and 7B comprise similar inclines 130. As described in detail herein, when the wheel polishing device 100 is positioned on a wheel stand 001 after a wheel has been mounted, the machined incline 130 interfaces with the peg expanding hub 160. In addition to the machined inclined 130, this first surface of the peg also includes a flat surface 202.

In operation, in one embodiment, the angle of the expanding hub 160 to the inclined surface 130 of the peg creates a frictional locking force. Less of an angle would not create the required increase of diameter to effectively reach the diameter range required. A steeper angle may increase the diameter range however it would interface at an angle that would not stay tight.

As previously noted, the wheel polishing device 100A illustrated in FIG. 8A illustrates two elastic bands 200, 210 that apply an inwardly directed force, forcing the pegs 120A towards the peg expanding hub 160 while the pegs remain seated within their respective tracks or slots 110A-C. For example, in one embodiment, this inwardly directed force is created by one or more biasing members. Such biasing members may comprise rubber or elastic bands. As illustrated in FIG. 8A, the wheel polishing device comprises a first biasing member 200 and a second biasing member 210. In one embodiment, the pegs comprise one or more cavities 135A-B (see FIGS. 5A-7B) to removably engage at least one biasing member. For example, in peg illustrated in FIG. 5B, the first peg 120A comprises a first cavity 135A and a second cavity 135B. Both cavities 135A-B are defined along an outer surface of the first peg 120A. The second peg 120B and the third peg 120C may comprise similar cavity arrangements.

In one embodiment, the peg expanding hub 160 is configured to be used with a nut 180. The nut 180 may be configured to threadedly engage the threaded rod or center screw 30. For example, as illustrated in FIG. 4C, the expanding peg hub 160 defines an internal seat 170. In one preferred arrangement, the nut 180 is configured to be positioned on the internal seat 170, and as the nut 180 pushing downwardly on the internal seat, the expanding peg hub is pushed downwardly towards the base plate member 105 which expands the pegs outwardly due to the inclined surface 130 on the peg.

The biasing members or elastic bands allow for the expansion of the pegs radially about the peg expanding hub 160 as the nut is tightened on the center screw 30. Similarly, the biasing members 200 and 210 allow for the retracting of the pegs when the peg expanding hub 160 and nut 180 are reversed.

For example, as the nut 180 is threadedly engaged to the center screw 30, as the nut 180 is rotated in a clock-wise direction this will exert a downward force on the machined incline surfaces 130 on the peg. This downward force will cause the plurality pegs to expand away from another, away from the peg expanding hub 160 and nut 180. As the nut 180 progresses along the center screw 30, the pegs continue to expand radially outward along each respect track defined by the base plate member 105. For example, as the nut 180 is seated within the peg expanding hub 160, an outer cylindrical surface of the peg expanding hub 160 acts upon the inclined surfaces 130 of the peg while the pegs extend radially outwardly along their respective tracks, and away from the peg expanding hub 160.

As the pegs are expanded, a lower feature of each of the peg interface with another radially extending away that provides support opposing the torsional forces that the pegs may see as the wheel is being polished or reconditioned. To accommodate a variety of wheel center openings or piloting diameters, a user can interchange the peg size and retaining bands. The interface with the expanding peg hub 160 and/or nut 180 does not need to be exchanged.

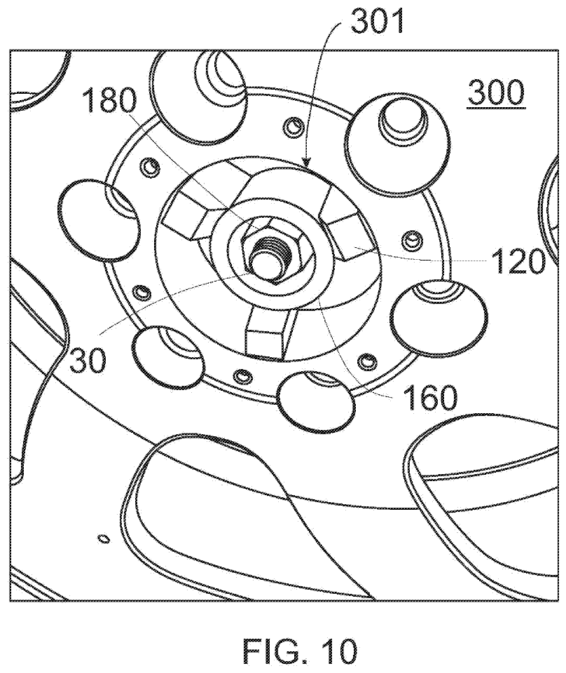

Referring now to FIG. 10, a detailed perspective view of the wheel polishing device in use is illustrated. During use, the inner piloting diameter 301 of the wheel 300 is positioned around the plurality of pegs 120. As nut 180 is tightened around center screw 30 which expands or forces peg expanding hub 180 outward and in turn pushing against the pegs such that they are also expanding outwardly into the piloting diameter of the wheel. Advantageously, the biasing members make the primary contact with the inner diameter of the piloting diameter preventing scratching, damage, or marks as the pegs expand gripping into the piloting diameter to secure the wheel to the device and attached wheel polishing stand. In other embodiments, the second surface (128; FIG. 5B) is the primary surface making contact with the piloting diameter. In some embodiments, the second surface 128 has a slight radius or curvature to create more surface area with the piloting diameter of the wheel. Further, there are no sharp corners on areas of the second surface 128 that could potential lead to damaging the wheels (see “R” in FIG. 7B as an example of the rounded corner locations). It should be understood, the rounded corners and curvature apply to all peg embodiments.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A wheel polishing device configured to couple with a wheel polishing stand, the wheel polishing device comprising:
a base plate member defining a plurality of tracks;
a plurality peg members, wherein each of the plurality of peg members are configured to slidably engage a track of the plurality of tracks defined by the base plate member; and
a peg expanding hub positioned centrally approximate to the base plate member, the peg expanding hub having a central aperture and an internal seat;
a center screw configured to pass through the central aperture of the peg expanding hub;
a nut configured to rotate on the center screw and engage the internal seat, wherein the nut is configured to push the internal seat and the peg expanding hub downwardly toward the base plate member, which pushes the plurality of peg member outwardly along the tracks such that the plurality of peg members are configured to engage an inner piloting diameter of a wheel to secure the wheel to the wheel polishing device.

2. The wheel polishing device of claim 1, wherein the rotational movement of the nut along the center screw in a downward direction moves the plurality of pegs in an outward direction, against an inwardly directed force created by one or more biasing members.

3. The wheel polishing device of claim 2, wherein the rotational movement of the nut along the center screws in an upward direction moves the plurality of peg members in an inward direction.

4. The wheel polishing device of claim 1, wherein the base plate member comprises three angled tracks that are machined at 120 degree increments about a circumference of the peg expanding hub.

5. The wheel polishing device of claim 4, wherein the plurality of peg members is 3.

6. The wheel polishing device of claim 1, wherein at least one of the plurality of peg members define one or more cavities to removably engage at least one biasing member.

7. The wheel polishing device of claim 6, wherein the one or more cavities are defined along an outer surface of each peg of the plurality of peg members.

8. The wheel polishing device of claim 1, wherein each peg of the plurality of peg members comprises an incline surface positioned against a matching incline surface on the peg expanding hub.

9. The wheel polishing device of claim 8, wherein the downward force of the nut on the internal seat engages the matching incline surface of the peg expanding hub along at least a portion of this incline surface of the plurality of peg members, such that each of the plurality of peg members moves along one of the plurality of the tracks.

10. The wheel polishing device of claim 8, wherein the incline surface extends only along a portion of a surface of each peg of the plurality of peg members.

11. The wheel polishing device of claim 8, wherein the peg expanding hub is cylindrical.

12. The wheel polishing device of claim 8, wherein each peg of the plurality of peg members defines a width associated with a specific inner diameter range of the inner dimeter of the piloting diameter of the wheel.

13. The wheel polishing device of claim 12, wherein the plurality of peg members may be exchanged with an alternative set of plurality of peg members having a second width such that the wheel polishing device may be used with other inner diameter ranges of different wheel's piloting diameters.

14. The wheel polishing device of claim 1, wherein the wheel polishing stand is manually powered.
